(19) United States
(12) Patent Application Publication
(10) Pub. No.: US 2023/0042666 A1
(43) Pub. Date: Feb. 9, 2023

(54) APPARATUS, SYSTEM, AND METHOD FOR ACHIEVING IMPROVED GROUND STATION DESIGN

(71) Applicant: Meta Platforms, Inc., Menlo Park, CA (US)

(72) Inventors: Farbod Tabatabai, San Francisco, CA (US); Eric Udell, Cypress, TX (US); Imad Shehab, La Jolla, CA (US); Srishti Saraswat, Santa Clara, CA (US)

(21) Appl. No.: 17/686,801

(22) Filed: Mar. 4, 2022

Related U.S. Application Data
(60) Provisional application No. 63/231,106, filed on Aug. 9, 2021.

(51) Int. Cl. H01P 7/06; H01P 11/00

(52) U.S. Cl. CPC H01P 7/06; H01P 11/008

(57) ABSTRACT

A radio-frequency device comprising (1) an input resonator configured to receive an input signal, (2) an output resonator configured to provide an output signal, and (3) a plurality of signal paths coupled between the input resonator and the output resonator, wherein each signal path included the plurality of signal paths comprises a bandpass filter that (A) is at least partially composed of a ceramic material and (B) has a bandpass center frequency different from every other signal path included in the plurality of signal paths. Various other apparatuses, systems, and methods are also disclosed.

### INCORPORATION BY REFERENCE

This application claims the benefit of priority under 35 U.S.C. §119(e) to U.S. Provisional Application No. 63/231,106, filed Aug. 9, 2021, the contents of which are incorporated herein by reference in their entirety.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is an illustration of an exemplary radio-frequency (RF) device that facilitates improved ground station design according to one or more embodiments of this disclosure.

FIG. 2 is an illustration of an exemplary RF device that facilitates improved ground station design according to one or more embodiments of this disclosure.

FIG. 3 is an illustration of an exemplary RF device that facilitates improved ground station design according to one or more embodiments of this disclosure.

FIG. 4 is an illustration of an exemplary RF device that facilitates improved ground station design according to one or more embodiments of this disclosure.

FIG. 5 is an illustration of an exemplary RF device that facilitates improved ground station design according to one or more embodiments of this disclosure.

FIG. 6 is an illustration of an exemplary RF device that facilitates improved ground station design according to one or more embodiments of this disclosure.

FIG. 7 is an illustration of an exemplary RF device that facilitates improved ground station design according to one or more embodiments of this disclosure.

FIG. 8 is an illustration of an exemplary RF device that facilitates improved ground station design according to one or more embodiments of this disclosure.

FIG. 9 is an illustration of an exemplary RF device that facilitates improved ground station design according to one or more embodiments of this disclosure.

FIG. 10 is an illustration of an exemplary RF device that facilitates improved ground station design according to one or more embodiments of this disclosure.

FIG. 11 is an illustration of an exemplary system including a satellite and a remote radio unit of a ground station according to one or more embodiments of this disclosure.

FIG. 12 is an illustration of exemplary irises capable of coupling resonators within RF devices according to one or more embodiments of this disclosure.

FIG. 13 is a flowchart of an exemplary method for achieving improved ground station design according to one or more embodiments of this disclosure.

FIG. 14 is an illustration of an exemplary system that includes various base stations that implement RF devices according to one or more embodiments of this disclosure.

FIG. 15 is an illustration of an exemplary system that includes various base stations that implement RF devices according to one or more embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for achieving improved ground station design. As will be explained in greater detail below, these apparatuses, systems, and methods may provide numerous features and benefits.

Ground station design typically aims for lower size, weight, power consumption, and/or cost. Sometimes these features are partially or collectively referred to as SWaP (size, weight, and power). Certain components (such as filters and/or waveguides) may dictate, control, and/or influence whether ground stations are able to achieve those aims. Some of those components may constitute and/or represent part of a remote radio unit in a ground station. Conventional examples of such components may include and/or form air-filled cavities fabricated from metals (e.g., aluminum). Unfortunately, those conventional components that include air-filled metal cavities may be physically large enough to result in a high insertion loss, thereby potentially increasing the power consumption of a corresponding power amplifier. Moreover, those conventional components that include air-filled cavities in a metal housing may also be relatively high cost and/or bulky (e.g., occupying nearly one third or even one half of the volume of a remote radio unit within a ground station).

The instant disclosure, therefore, identifies and addresses a need for additional apparatuses, systems, and methods for achieving improved ground station design. In some instances, the weight, bulk, and/or cost of RF components may be reduced using solid dielectric components rather than air-filled metal cavities. Dielectric components (such as ceramic resonators and/or ceramic waveguides) may facilitate and/or provide significant reductions in the volume and/or weight of RF devices. RF devices may include and/or represent components of an RF circuit (such as a cellular ground station).

In some examples, the use of ceramic in place of air-filled metal cavities may help reduce the size of the components included in RF devices. As a result, the overall size of such RF devices and/or corresponding systems may also decrease. The size reduction and/or decrease may be by factor of √(εᵣ), where εᵣ represents the relative dielectric constant of the dielectric material (such as a ceramic) at an operational frequency. In addition, certain ceramic components may facilitate and/or provide improved electrical and/or RF connections compared with those achieved via air-filled cavities in metal housings.

In some examples, RF devices may achieve improved electrical and/or RF connections between RF connectors (such as coaxial connectors) and ceramic-based components (such as waveguides, filters, etc.). Some RF devices may be configured and/or designed for operation at radio frequencies, including communication network frequencies like those implemented in 3G bands, 4G bands, long-term evolution (LTE) bands, wireless broadband communication protocol bands, and/or 5G bands.

In some examples, such RF devices may include and/or represent ceramic-based components like waveguides, resonators, and/or filters (e.g., bandpass filters and/or multiple bandpass filters with different band center frequencies). The SWaP and cost of an RF device that includes ceramic components may be greatly improved compared to an RF device that includes components with air-filled metal cavities.

In some examples, electrical and/or RF connections may be formed and/or implemented between RF components like an RF connector and an RF ceramic waveguide. Alternative electrical and/or RF connections may be formed and/or implemented between an RF connector and a ceramic filter or resonator. Additional electrical and/or RF connections may be formed and/or implemented between two ceramic waveguides or between a ceramic waveguide and a ceramic resonator. In one example, an RF connector may include and/or represent a waveguide, a coaxial connector, and/or another signal conveyance mechanism.

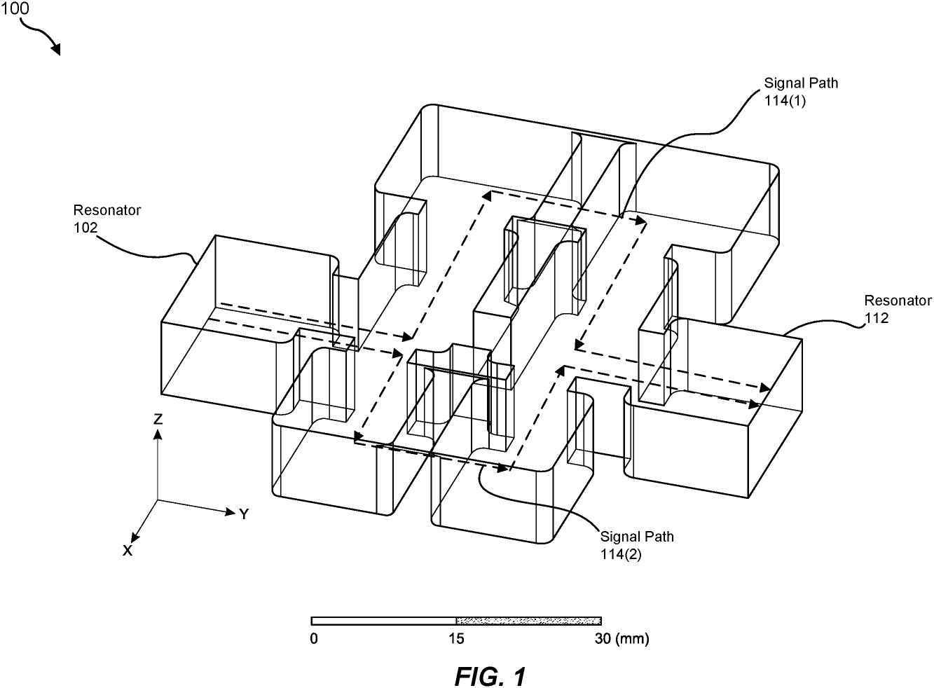

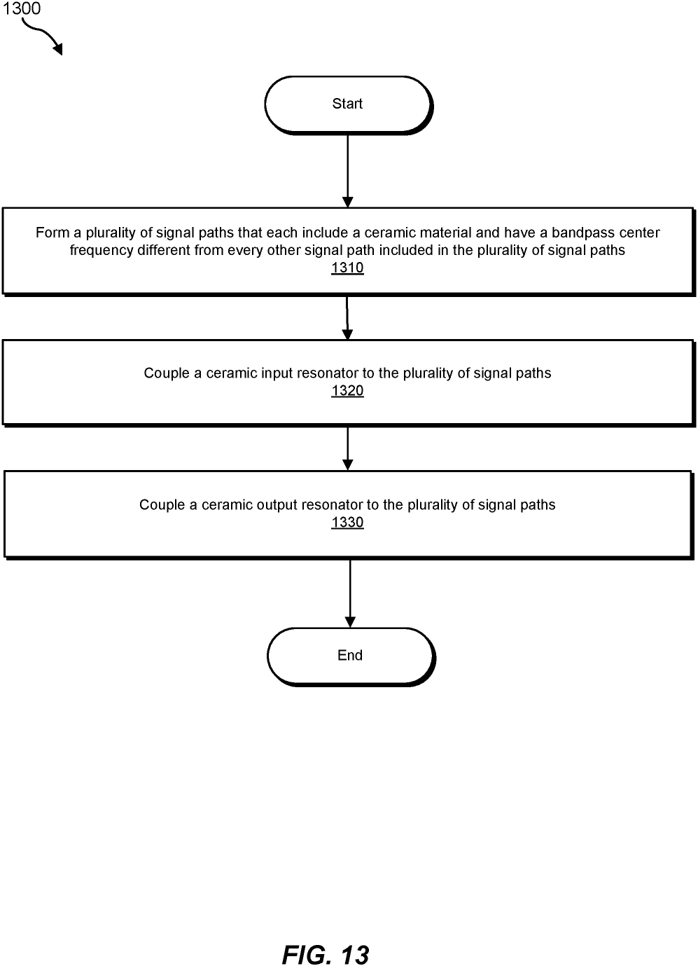

The following will provide, with reference to FIGS. 1-12, 14, and 15, detailed descriptions of exemplary apparatuses, systems, components, and structures for achieving improved ground station design. In addition, detailed descriptions of exemplary methods for achieving improved ground station design will be provided in connection with FIG. 13.

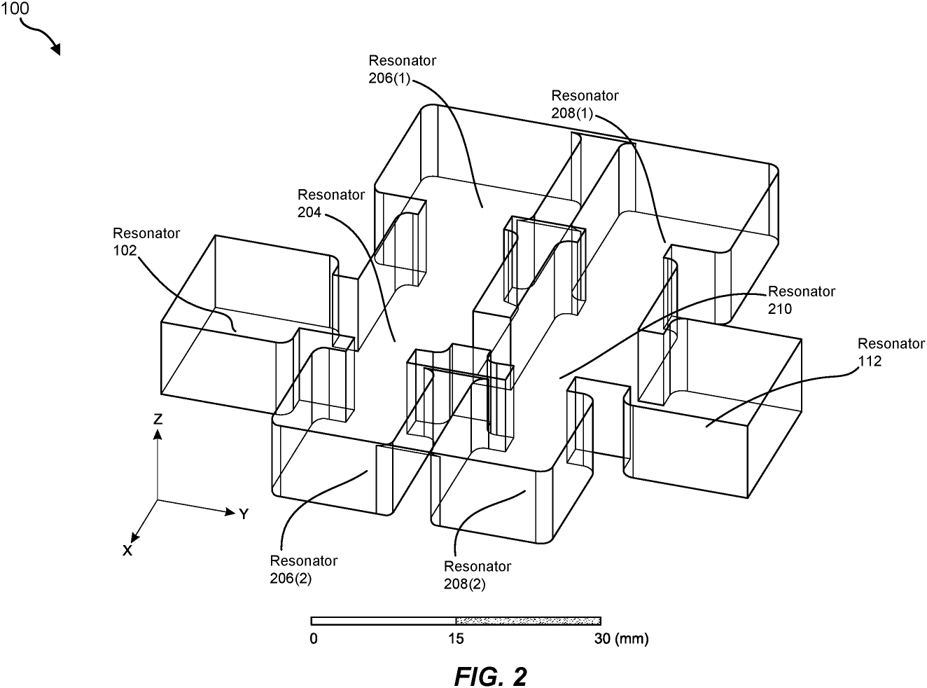

FIGS. 1 and 2 illustrate an exemplary RF device 100 that includes and/or represents various resonators made at least in part from ceramic material. In some examples, RF device 100 may include and/or represent a dual bandpass filter whose ceramic material facilitates reducing and/or decreasing the SWaP and/or cost relative to certain conventional configurations and/or implementations. As a result, RF device 100 may enable ground stations to achieve improved designs, especially in terms of the SWAP and/or cost.

As illustrated in FIGS. 1 and 2, RF device 100 may include and/or represent a resonator 102 and a resonator 112. In some examples, resonator 102 may include and/or represent an input connector configured to receive and/or accept an input signal for at least partial transmission and/or passage through RF device 100. In such examples, resonator 112 may include and/or represent an output connector configured to provide and/or deliver an output signal for transmission and/or emission from another feature and/or component of RF device 100.

As illustrated in FIG. 1, RF device 100 may include and/or represent signal paths 114(1) and 114(2) coupled between resonators 102 and 112. In some examples, signal paths 114(1) and 114(2) may collectively include and/or represent at least a portion of a dual bandpass filter. In such examples, signal path 114(1) may constitute and/or represent at least a portion of one bandpass filter, and signal path 114(2) may constitute and/or represent at least a portion of another bandpass filter.

In some examples, signal paths 114(1) and 114(2) may each include and/or represent a plurality of additional resonators coupled between resonators 102 and 112. For example, signal path 114(1) may include and/or represent resonators 204, 206(1), 208(1), and/or 210 in FIG. 2. In this example, signal path 114(2) may include and/or represent resonators 204, 206(2), 208(2), and/or 210 in FIG. 2.

In some examples, signal paths 114(1) and 114(2) may share certain resonators in common. For example, signal paths 114(1) and 114(2) may share resonator 102 and/or resonator 204 in common on the input side of RF device 100. Additionally or alternatively, signal paths 114(1) and 114(2) may share resonator 210 and/or resonator 112 in common on the output side of RF device 100.

Although not necessarily labelled in FIGS. 1 or 2, RF device 100 may also include and/or represent coupling structures that effectively couple and/or connect one or more of resonators 102, 204, 206(1), 206(2), 208(1), 208(2), 210, and/or 112 to one another. In some examples, and as will be described in greater detail below, such coupling structures may include and/or represent waveguide irises and/or windows. In one example, such coupling structures may electromagnetically connect and/or interface one resonator to another for the purpose of supporting and/or facilitating one or more signal paths. Examples of such waveguide irises and/or windows include, without limitation, inductive irises, conductive irises, parallel resonance irises, impedance-matching windows, combinations or variations of one or more of the same, and/or any other suitable waveguide irises or windows.

In some examples, one or more of resonators 102, 204, 206(1), 208(1), 210, and 112 included in signal path 114(1) may be at least partially composed of one or more ceramic materials. In such examples, one or more of resonators 102, 204, 206(2), 208(2), 210, and 112 included in signal path 114(2) may be at least partially composed of one or more ceramic materials. In one example, the bandpass filter formed and/or represented by signal path 114(1) may have and/or provide a certain bandpass center frequency. In this example, the bandpass filter formed and/or represented by signal path 114(2) may have and/or provide another bandpass center frequency that differs from the one provided by and/or corresponding to signal path 114(1). For example, the bandpass filter formed and/or represented by signal path 114(2) may have and/or provide a bandpass center frequency that is at least 10% higher or lower than the one provided by and/or corresponding to signal path 114(1).

In some examples, the bandpass filter formed and/or represented by signal path 114(1) may have and/or provide a bandpass center frequency that is outside of the pass band of signal path 114(2). Additionally or alternatively, the bandpass filter formed and/or represented by signal path 114(2) may have and/or provide a bandpass center frequency that is outside of the pass band of signal path 114(1).

In some examples, the bandpass center frequency of signal path 114(1) may be defined and/or controlled at least in part by one or more dimensions (e.g., the total size) of resonators 102, 204, 206(1), 208(1), 210, and 112. For example, the dimensions of one or more of resonators 102, 204, 206(1), 208(1), 210, and 112 may be tuned to achieve and/or obtain a certain bandpass center frequency for signal path 114(1). Additionally or alternatively, the bandpass center frequency of signal path 114(2) may be defined and/or controlled at least in part by one or more dimensions (e.g., the total size) of resonators 102, 204, 206(2), 208(2), 210, and 112. For example, the dimensions of one or more of resonators 102, 204, 206(2), 208(2), 210, and 112 may be tuned to achieve and/or obtain a certain bandpass center frequency for signal path 114(2).

In some examples, the bandpass center frequency of signal path 114(1) may be defined and/or controlled at least in part by the size and/or volume of a cavity within one or more of resonators 102, 204, 206(1), 208(1), 210, and 112. For example, the size and/or volume of a cavity within one or more of resonators 102, 204, 206(1), 208(1), 210, and 112 may be tuned to achieve and/or obtain a certain bandpass center frequency for signal path 114(1). Additionally or alternatively, the bandpass center frequency of signal path 114(2) may be defined and/or controlled at least in part by the size and/or volume of a cavity within one or more of resonators 102, 204, 206(2), 208(2), 210, and 112. For example, the size and/or volume of a cavity within one or more of resonators 102, 204, 206(2), 208(2), 210, and 112 may be tuned to achieve and/or obtain a certain bandpass center frequency for signal path 114(2).

The cross-section of resonators 102, 204, 206(1), 206(2), 208(1), 208(2), 210, and/or 112 may be any of a variety of shapes and/or dimensions. For example, one or more of resonators 102, 204, 206(1), 206(2), 208(1), 208(2), 210, and/or 112 may be rectangular and/or box-shaped. Additional examples of shapes formed by resonators 102, 204, 206(1), 206(2), 208(1), 208(2), 210, and/or 112 include, without limitation, ovoids, cubes, cuboids, spheres, spheroids, cones, prisms, cylinders, disks, fin-shaped structures, variations or combinations of one or more of the same, and/or any other suitable shapes.

In some examples, resonators 102, 204, 206(1), 206(2), 208(1), 208(2), 210, and/or 112 may be sized in a particular way to interface with and/or couple to one another or to achieve and/or obtain a certain bandpass center frequency along one or more signal paths. Resonators 102, 204, 206(1), 206(2), 208(1), 208(2), 210, and/or 112 may include and/or contain any of a variety of materials. In one example, one or more of resonators 102, 204, 206(1), 206(2), 208(1), 208(2), 210, and/or 112 may include and/or contain ceramic materials. Additional examples of such materials include, without limitation, inorganic nonmetallic materials, clays, silicas, silicons, porcelains, mullites, stonewares, earthenwares, oxide materials, nitride materials, carbon materials, carbide materials, kaolinites, tungsten carbides, silicon carbides, variations or combinations of one or more of the same, and/or any other suitable materials.

In some examples, RF device 100 may constitute and/or represent a filter fabricated and/or manufactured with ceramic resonators. In one example, the filter may have an input on the left side (as illustrated in FIGS. 1 and 2) and an output on the right (as illustrated in FIGS. 1 and 2). The input and output may include and/or represent input and output connectors. RF device 100 may be configured to pass two frequency bands, thereby providing a dual-band filter in a single device. The pass bands may be at any suitable band frequencies, and the bandwidth may also be adjusted as desired. The design and/or configuration illustrated in FIGS. 1 and 2 may depict a filter capable of supporting both band 1 and band 3 of the LTE spectrum.

In some examples, the use of the ceramic may reduce the size of the resonators and in turn the overall size of the filter. In one example, the size reduction may reach a factor of √(εᵣ), where εᵣ represents the relative dielectric constant of the filter material at an operational frequency.

In some examples, RF device 100 may include and/or represent various block-like elements, such as generally cuboid ceramic resonators, stages, or cavities. In one example, a resonator may be provided and/or formed by a ceramic element rather than an air-filled cavity. In this example, the resonator may be implemented and/or applied in 4-pole filter.

In some examples, a signal may be transmitted along resonator 102, which serves as an input waveguide. In one example, the input waveguide may receive a filter input signal from a power amplifier and then transmit the filter input signal to resonator 204. Similarly, the output signal may be received by resonator 112, which serves as an output waveguide. In this example, the output waveguide may deliver and/or provide the output signal to one or more antennas for transmission. Accordingly, the input signal of the filter may constitute and/or represent the output signal of the power amplifier, and the output signal of the filter may constitute and/or represent the transmission signal of the antenna.

In some examples, the filter may provide a plurality of possible paths between the input stage and the output stage. For example, such possible paths may include and/or represent signal path 114(1), signal path 114(2), and/or a direct path between resonators 204 and 210. In one example, when implemented as a bidirectional application, the filter may provide analogous reverse paths for a signal arriving at resonator 112 instead of resonator 102.

In some examples, the transmission of a particular input signal may depend on the frequency components of the signal and the bandpass characteristics of the various resonators. In such examples, the bandpass characteristics of each resonator may be modified by adjusting the physical dimensions of those resonators. For example, resonators 206(1) and 208(1) may have dimensions and bandpass parameters that are similar to one another. In this example, resonators 206(2) and 208(2) may have dimensions and bandpass parameters that are similar to one another but different than those of resonators 206(1) and 208(1). In one example, the height (e.g., the z-direction illustrated in FIGS. 1 and 2) of all the resonators may be the same, but the widths of the resonators may vary and/or differ. In this example, as a result of the differing widths, signal paths 114(1) and 114(2) may have bandpass parameters that differ from those of signal paths 114(1) and 114(2).

In one example, RF device 100 may include and/or represent at least four inductive irises (although not necessarily labelled in FIGS. 1 or 2). In this example, one iris may be located at the input of RF device 100, and one iris may be located at output of RF device 100. These input and output irises may be shared by both bands. Inductive irises may also be located at the connection between resonators 204 and 206(1) and at the connection between resonators 208(1) and 210 along signal path 114(1). Similarly, inductive irises may also be located at the connection between resonators 204 and 206(2) and at the connection between resonators 208(2) and 210 along signal path 114(2).

The first band may represent and/or follow signal path 114(1), and the second band may represent and/or follow signal path 114(2). In addition to the inductive irises described above, capacitive irises may be located at the connection between resonators 208(1) and 210 along signal path 114(1) and at the connection between resonators 208(2) and 210 along signal path 114(2).

Frequency parameters of example RF devices (e.g., bandwidths and/or center frequencies of one or more transmitted frequency bands) may be defined by the resonator size and/or the coupling structure configurations. Resonator size may include and/or represent the resonator length, width, and/or height a generally cuboid form factor. Additionally or alternatively, the bandpass center frequency of a bandpass filter may be related to and/or defined by one or more resonator dimensions. For example, a resonator dimension (e.g., a resonator width) may be approximately equal to one quarter wavelength of the bandpass center frequency. In some examples, a single RF device may include resonators having different dimensions, thus facilitating the fabrication of multi-band filters (e.g., dual-band filters).

In some examples, coupling structure configurations may include and/or represent the size and/or arrangement of capacitive irises and/or inductive irises within couplings between neighboring resonators. The bandwidth parameters of signal paths 114(1) and 114(2) through the dual-band filter may be modified by the adjusting the dimensions of one or more inductive and/or capacitive irises used to couple neighboring resonators. The bandpass center frequency and bandwidth may be separately and/or independently controlled by resonator and/or iris dimension adjustments (e.g., during fabrication of the device). In one example, RF device 100 may be configured to have one or more different pass bands for different polarizations of radiation.

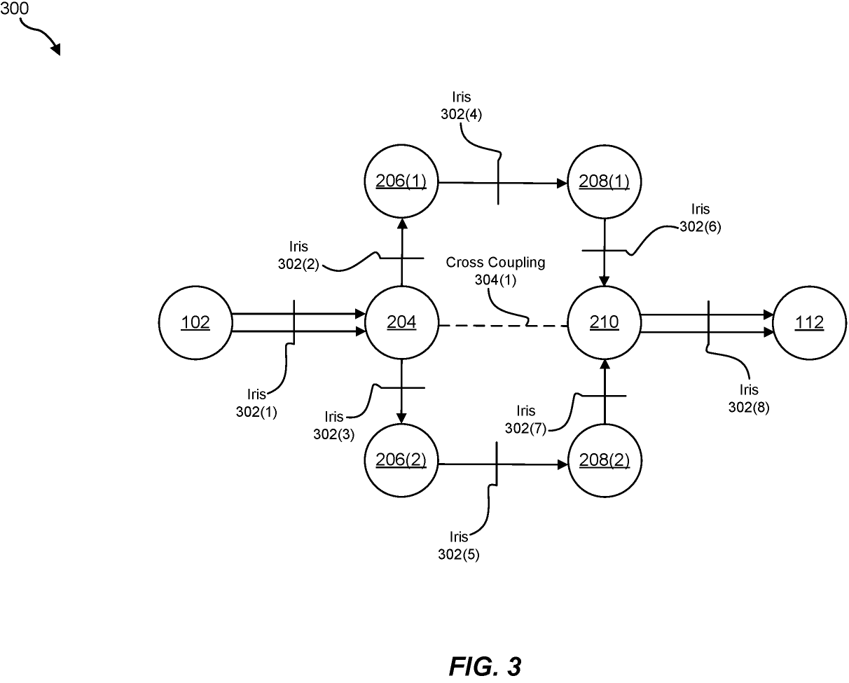

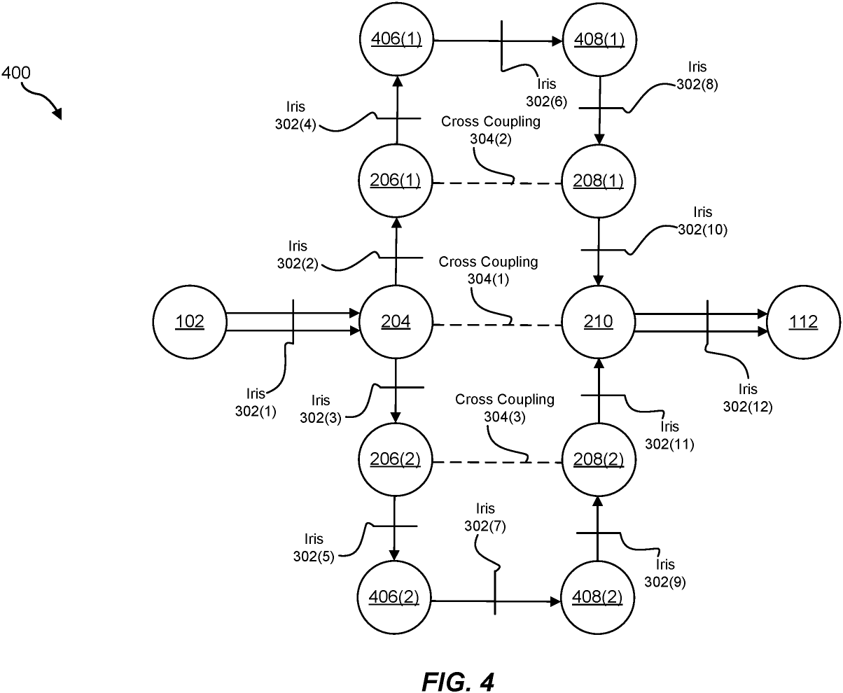

FIGS. 3 and 4 illustrate exemplary RF devices 300 and 400, respectively, that include and/or represent various resonators made at least in part from ceramic material. In some examples, RF devices 300 and 400 may each include and/or represent a dual bandpass filter whose ceramic material facilitates reducing and/or decreasing the SWaP and/or cost relative to certain conventional configurations and/or implementations. As a result, RF devices 300 and 400 may enable ground stations to achieve improved designs, especially in terms of the SWAP and/or cost.

In some examples, RF devices 300 and 400 may each constitute and/or represent a compact multipole filter for dual band operation. In one example, RF device 300 may constitute and/or represent a 4-pole ceramic dual bandpass filter implemented and/or configured with resonators 102, 204, 206(1), 206(2), 208(1), 208(2), 210, and/or 112. For example, resonator 102 and resonator 112 may constitute an input connector and an output connector, respectively. In this example, the 4-pole ceramic dual bandpass filter may include and/or represent signal paths 114(1) and 114(2) (although not necessarily labelled as such in FIGS. 3 or 4) coupled between resonators 102 and 112.

In some examples, signal path 114(1) of the 4-pole ceramic dual bandpass filter may include and/or represent resonators 204, 206(1), 208(1), and/or 210 coupled between resonators 102 and 112. More specifically, resonator 204 may be coupled and/or positioned between resonators 102 and 206(1). Similarly, resonator 206(1) may be coupled and/or positioned between resonators 204 and 208(1), and resonator 208(1) may be coupled and/or positioned between resonators 206(1) and 210. In addition, resonator 210 may be coupled and/or positioned between resonators 208(1) and 112.

In some examples, signal path 114(2) may include and/or represent resonators 204, 206(2), 208(2), and/or 210 coupled between resonators 102 and 112. More specifically, resonator 204 may be coupled and/or positioned between resonators 102 and 206(2). Similarly, resonator 206(2) may be coupled and/or positioned between resonators 204 and 208(2), and resonator 208(2) may be coupled and/or positioned between resonators 206(2) and 210. In addition, resonator 210 may be coupled and/or positioned between resonators 208(2) and 112.

As illustrated in FIG. 3, RF device 300 may also include and/or represent certain coupling structures positioned, located, and/or placed between one or more of resonators 102, 204, 206(1), 206(2), 208(1), 208(2), 210, and/or 112. For example, an iris 302(1) may electromagnetically couple, connect, and/or interface resonators 102 and 204 to one another along signal paths 114(1) and 114(2). In one example, an iris 302(2) may electromagnetically couple, connect, and/or interface resonators 204 and 206(1) to one another along signal path 114(1), and an iris 302(3) may electromagnetically couple, connect, and/or interface resonators 204 and 206(2) to one another along signal path 114(2). In this example, an iris 302(4) may electromagnetically couple, connect, and/or interface resonators 206(1) and 208(1) to one another along signal path 114(1), and an iris 302(5) may electromagnetically couple, connect, and/or interface resonators 206(2) and 208(2) to one another along signal path 114(2).

Continuing with this example, an iris 302(6) may electromagnetically couple, connect, and/or interface resonators 208(1) and 210 to one another along signal path 114(1), and an iris 302(7) may electromagnetically couple, connect, and/or interface resonators 208(2) and 210 to one another along signal path 114(2). Finally, an iris 302(8) may electromagnetically couple, connect, and/or interface resonators 210 and 112 to one another along signal paths 114(1) and 114(2).

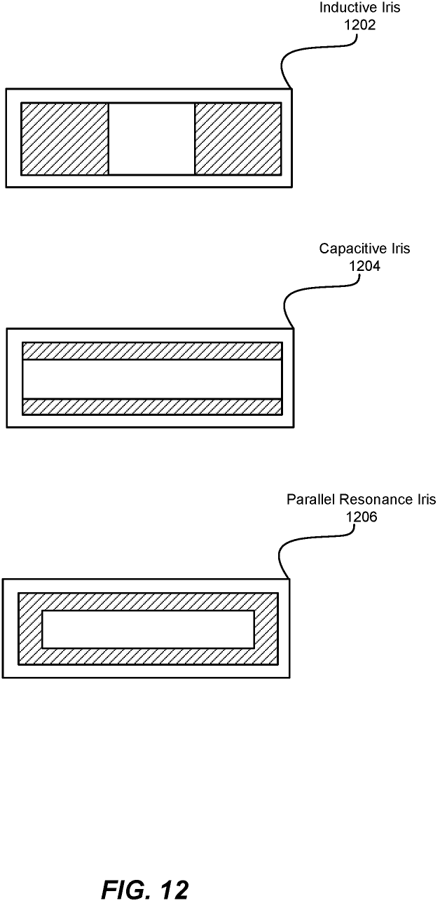

FIG. 12 illustrates different configurations and/or implementations of irises capable of being applied between resonators within certain RF devices. In some examples, an inductive iris 1202 in FIG. 12 may be applied and/or disposed between two resonators at a position where the magnetic field is strong and/or the electric field is weak. In other examples, a capacitive iris 1204 in FIG. 12 may be applied and/or disposed between two resonators at a position where the electric field is strong. In further examples, a parallel resonance iris 1206 in FIG. 12 may be applied and/or disposed between two resonators to provide high impedance and/or a negligible shunting effect.

In one example, RF device 400 may constitute and/or represent a 6-pole ceramic dual bandpass filter implemented and/or configured with resonators 102, 204, 206(1), 206(2), 406(1), 406(2), 408(1), 408(2), 208(1), 208(2), 210, and/or 112. For example, resonator 102 and resonator 112 may constitute an input connector and an output connector, respectively. In this example, the 6-pole ceramic dual bandpass filter may include and/or represent signal paths 114(1) and 114(2) (although not necessarily labelled as such in FIGS. 3 or 4) coupled between resonators 102 and 112.

In some examples, signal path 114(1) of the 6-pole ceramic dual bandpass filter may include and/or represent resonators 204, 206(1), 406(1), 408(1), 208(1), and/or 210 coupled between resonators 102 and 112. More specifically, resonator 204 may be coupled and/or positioned between resonators 102 and 206(1). Similarly, resonator 206(1) may be coupled and/or positioned between resonators 204 and 406(1), and resonator 406(1) may be coupled and/or positioned between resonators 206(1) and 408(1). In addition, resonator 408(1) may be coupled and/or positioned between resonators 406(1) and 208(1), and resonator 208(1) may be coupled and/or positioned between resonators 408(1) and 210.

In some examples, signal path 114(2) may include and/or represent resonators 204, 206(2), 208(2), and/or 210 coupled between resonators 102 and 112. More specifically, resonator 204 may be coupled and/or positioned between resonators 102 and 206(2). Similarly, resonator 206(2) may be coupled and/or positioned between resonators 204 and 406(2), and resonator 406(2) may be coupled and/or positioned between resonators 206(2) and 408(2). In addition, resonator 408(2) may be coupled and/or positioned between resonators 406(2) and 208(2), and resonator 208(2) may be coupled and/or positioned between resonators 408(2) and 210.

As illustrated in FIG. 4, RF device 400 may also include and/or represent certain coupling structures positioned, located, and/or placed between one or more of resonators 102, 204, 206(1), 206(2), 406(1), 406(2), 408(1), 408(2), 208(1), 208(2), 210, and/or 112. For example, iris 302(1) may electromagnetically couple, connect, and/or interface resonators 102 and 204 to one another along signal paths 114(1) and 114(2). In one example, iris 302(2) may electromagnetically couple, connect, and/or interface resonators 204 and 206(1) to one another along signal path 114(1), and iris 302(3) may electromagnetically couple, connect, and/or interface resonators 204 and 206(2) to one another along signal path 114(2). In this example, iris 302(4) may electromagnetically couple, connect, and/or interface resonators 206(1) and 406(1) to one another along signal path 114(1), and iris 302(5) may electromagnetically couple, connect, and/or interface resonators 206(2) and 406(2) to one another along signal path 114(2).

Continuing with this example, iris 302(6) may electromagnetically couple, connect, and/or interface resonators 406(1) and 408(1) to one another along signal path 114(1), and iris 302(7) may electromagnetically couple, connect, and/or interface resonators 406(2) and 408(2) to one another along signal path 114(2). Moreover, iris 302(8) may electromagnetically couple, connect, and/or interface resonators 408(1) and 208(1) to one another along signal path 114(1), and an iris 302(9) may electromagnetically couple, connect, and/or interface resonators 408(2) and 208(2) to one another along signal path 114(2). Further, an iris 302(10) may electromagnetically couple, connect, and/or interface resonators 208(1) and 210 to one another along signal path 114(1), and an iris 302(11) may electromagnetically couple, connect, and/or interface resonators 208(2) and 210 to one another along signal path 114(2). Finally, an iris 302(12) may electromagnetically couple, connect, and/or interface resonators 210 and 112 to one another along signal paths 114(1) and 114(2).

In some examples, one or more of irises 302(1)-(12) may facilitate, provide, and/or support impedance matching and/or continuity from one resonator to another within RF device 300 or 400. Accordingly, by coupling the various resonators with such irises, RF device 300 or 400 may be able to mitigate and/or eliminate reflections that would otherwise impair its performance and/or efficiency.

In some examples, one or more of irises 302(1)-(12) may include and/or represent a plate and/or frame that forms an opening and/or window between two resonators. In such examples, irises 302(1)-(12) may enable electromagnetic radiation (e.g., radio waves) to pass, propagate, travel, and/or traverse from one resonator to another. In one example, irises that provide and/or offer positive reactance and/or impedance may constitute and/or represent inductive irises. In this example, irises that provide and/or offer negative reactance and/or impedance may constitute and/or represent capacitive irises.

In some examples, one or more of irises 302(1)-(12) may constitute and/or represent an inductive iris that causes current to flow and/or causes energy to be stored in a magnetic field, thereby increasing the inductance at that location within the waveguide. In other examples, one or more of irises 302(1)-(12) may constitute and/or represent a capacitive iris that provides and/or generates capacitive susceptance parallel to an electric field, thereby increasing the capacitance at that location within the waveguide. In further examples, one or more of irises 302(1)-(12) may constitute and/or represent a combination and/or integration of an inductive iris and a capacitive iris such that the inductive and/or capacitive reactances provided are substantially equal, thereby forming and/or resulting in a parallel resonance iris and/or circuit.

In some examples, irises 302(1)-(12) may be sized in a particular way to facilitate interfacing with and/or coupling resonators to one another or to achieve and/or obtain a certain bandpass center frequency along one or more signal paths. Irises 302(1)-(12) may include and/or contain any of a variety of materials. In one example, one or more of irises 302(1)-(12) may include and/or contain ceramic materials. Additional examples of such materials include, without limitation, inorganic nonmetallic materials, clays, silicas, silicons, porcelains, mullites, stonewares, earthenwares, oxide materials, nitride materials, carbon materials, carbide materials, kaolinites, tungsten carbides, silicon carbides, metals, variations or combinations of one or more of the same, and/or any other suitable materials.

In some examples, RF device 300 or 400 may omit and/or exclude one or more of the irises illustrated in FIGS. 3 or 4. For example, RF device 300 may omit and/or exclude iris 302(4) and/or iris 302(5). In this example, one or more of irises 302(6)-(8) may constitute and/or represent a capacitive iris and/or a parallel resonance iris. As another example, RF device 400 may omit and/or exclude iris 302(6) and/or iris 302(7). In this example, one or more of irises 302(10)-(12) may constitute and/or represent a capacitive iris and/or a parallel resonance iris.

As illustrated in FIGS. 3 and 4, certain resonators included in RF devices 300 and 400 may be connected to one another by a cross coupling (sometimes also referred to as a crossover coupling). For example, RF device 300 in FIG. 3 may include and/or represent a cross coupling 304(1) applied and/or disposed between resonators 204 and 210. In another example, RF device 400 in FIG. 4 may include and/or represent a cross coupling 304(1) applied and/or disposed between resonators 204 and 210, a cross coupling 304(2) applied and/or disposed between resonators 206(1) and 208(1), and/or a cross coupling 304(3) applied and/or disposed between resonators 206(2) and 208(2).

In some examples, cross couplings 304(1)-(3) may each include and/or represent a zero transition that improves and/or bolsters the rejection properties of the dual bandpass filter. Such rejection properties may also be improved and/or bolstered by increasing the number of poles in the dual bandpass filter. In one example, for single-mode resonators, the number of poles may correspond to and/or reflect the number of resonators in the signal paths 114(1) and 114(2) (including, e.g., the input and output resonators).

In some examples, the zero transition couplings may provide, facilitate, and/or support alternative paths in addition to signal paths 114(1) and 114(2). The zero transition couplings may be used to sharpen the band edges in the filter response versus frequency function. In one example, the zero transition couplings may be configured to provide a null in the transmission frequency response of the filter on one or both sides of the pass band. Without the provision of zero transition couplings, a pass band may be surrounded by upper and lower frequency skirt regions in which the filter transmission falls as the frequency moves away from the pass band. A bandpass filter with a sharper reduction in filter transmission as a function of the frequency outside of the pass band may be achieved by locating a response null in one or both of the skirt regions.

In some examples, cross couplings 304(1)-(3) may each be sized in a particular way to facilitate interfacing with and/or coupling resonators to one another or to improve and/or bolster the rejection properties of a bandpass filter. Cross couplings 304(1)-(3) may include and/or contain any of a variety of materials. In one example, one or more of cross couplings 304(1)-(3) may include and/or contain ceramic materials. Additional examples of such materials include, without limitation, inorganic nonmetallic materials, clays, silicas, silicons, porcelains, mullites, stonewares, earthenwares, oxide materials, nitride materials, carbon materials, carbide materials, kaolinites, tungsten carbides, silicon carbides, metals, variations or combinations of one or more of the same, and/or any other suitable materials.

The number of resonators and/or poles for signal paths 114(1) and 114(2) may be the same, for example, as shown in FIGS. 3 and 4. In some applications, it may be useful for one path to have a greater number of poles than the other path. For example, a dual band filter may include and/or represent 4 poles in the first path and 6 poles in the second path.

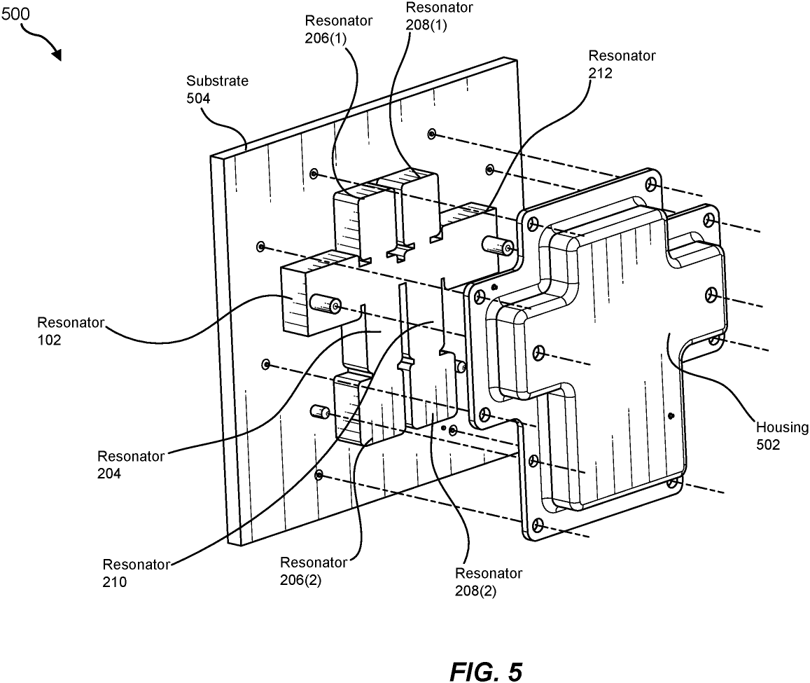

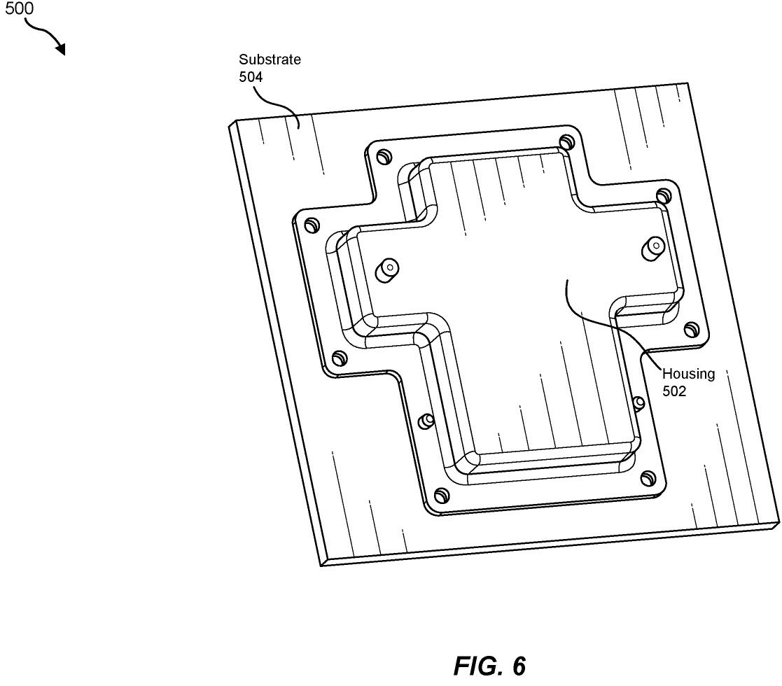

FIGS. 5 and 6 illustrate different views of an exemplary RF device 500 that includes and/or represents various resonators made at least in part from ceramic material. In some examples, RF device 500 may include and/or represent a dual bandpass filter whose ceramic material facilitates reducing and/or decreasing the SWaP and/or cost relative to certain conventional configurations and/or implementations. As a result, RF device 500 may enable ground stations to achieve improved designs, especially in terms of the SWAP and/or cost.

In some examples, RF device 500 may include and/or represent resonators 102, 204, 206(1), 206(2), 208(1), 208(2), 210, and/or 112 coupled and/or connected to one another to form a dual bandpass filter. In one example, resonators 102, 204, 206(1), 206(2), 208(1), 208(2), 210, and/or 112 may be disposed and/or formed on a substrate 504 of RF device 500. In this example, RF device 500 may also include and/or represent a housing 502 configured and/or designed to cover and/or enclose resonators 102, 204, 206(1), 206(2), 208(1), 208(2), 210, and/or 112 atop or over substrate 504. As illustrated in FIG. 6, housing 502 may be coupled and/or connected to substrate 504 to protect and/or preserve resonators 102, 204, 206(1), 206(2), 208(1), 208(2), 210, and/or 112 for RF device 500.

In some examples, an example RF device may include and/or represent an input connector coupled to an input resonator, an input port coupling the input resonator to a multi-mode resonator, an output port coupling the multi-mode resonator to an output resonator, and an output connector coupled to the output resonator. The input or output connector may include and/or represent a central conductor surrounded by an electrical insulator layer.

In some examples, the input resonator may include and/or represent a single-mode resonator, and the output resonator may also include and/or represent a single-mode resonator. The multi-mode resonator located between the input resonator and the output resonator may support multiple modes having multiple different resonant frequencies. In one example, the multi-mode resonator may have three resonant modes.

In some examples, the input port coupling the input resonator to the multi-mode resonator may include and/or represent a first slot, and the output port coupling the multi-mode resonator to the output resonator may include and/or represent a second slot. The first and second slots may be formed in separate electrically conducting sheets, such as metal layers. The electrically conducting sheets may include and/or represent one or more metals (such as gold, silver, aluminum, copper, etc.) and/or any other suitable electrical conductor.

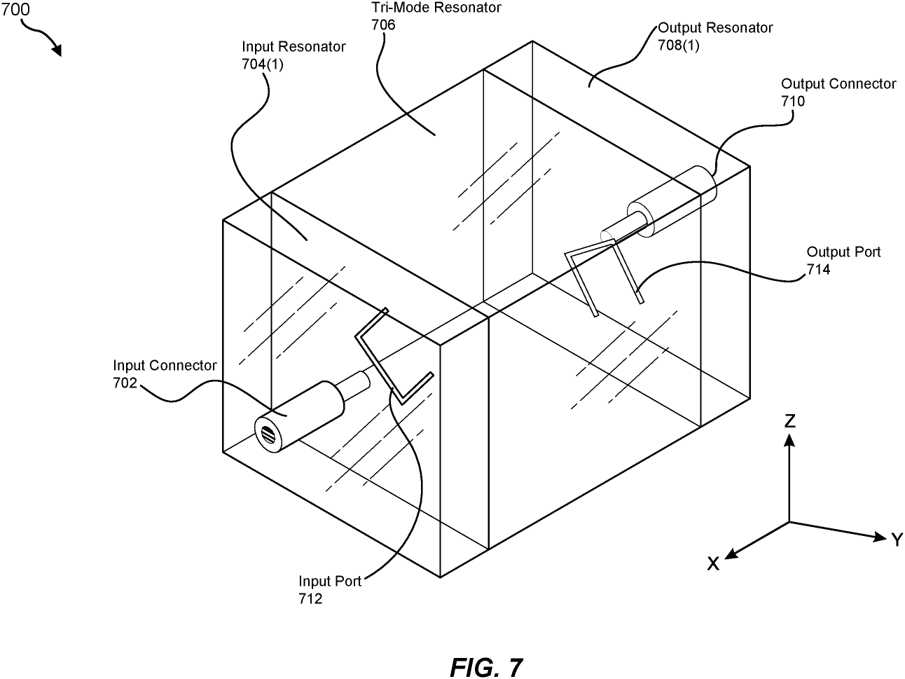

FIG. 7 illustrates an exemplary ceramic waveguide tri-mode bandpass filter 700. As illustrated in FIG. 7, exemplary ceramic waveguide tri-mode bandpass filter 700 may include and/or represent an input connector 702, a single-mode input resonator 704(1), an input port 712 coupling single-mode input resonator 704(1) to a tri-mode resonator 706, an output port 714 coupling tri-mode resonator 706 to a single-mode output resonator 708(1), and an output connector 710 coupled to output resonator 708(1). In some examples, exemplary ceramic waveguide tri-mode bandpass filter 700 may provide a single pass band, and the performance of ceramic waveguide tri-mode bandpass filter 700 may be improved through the inclusion of tri-mode resonator 706 and appropriate configurations of input port 712 and output port 714.

In some examples, exemplary ceramic waveguide tri-mode bandpass filter 700 may be classified as a 1:3:1 filter, as it includes a tri-mode resonator located between two single-mode resonators. Other configurations may also be possible, such as a 1:3:1:3:1 filter or another configuration of single-mode, dual-mode, and/or tri-mode resonators.

In some examples, input port 712 to tri-mode resonator 706 may include and/or represent a first U-shaped slot, and output port 714 from tri-mode resonator 706 may include and/or represent a second U-shaped slot that is rotated (e.g., 90-degrees offset) relative to the first U-shaped slot. A single mode from input resonator 704(1) may be coupled through the input U-shaped slot into the three resonant modes of tri-mode resonator 706. The three resonant modes of tri-mode resonator 706 may then be coupled through the output U-shaped slot (a second shifted-rotated slot relative to the input U-shaped slot) into a single mode in output resonator 708(1). The output signal from output resonator 708(1) may then be coupled to output connector 710.

In some examples, tri-mode resonator 706 may include and/or represent an approximately quarter wavelength (X/4) resonator, and one or more dimensions of tri-mode resonator 706 may define the resonant frequencies. In one example, a cubic resonator may exhibit the same resonant frequencies for three orthogonal modes. However, if two or more dimensions are different, the resonant frequencies may correspondingly differ.

In some examples, tri-mode resonator 706 may include and/or represent a cuboid-shaped resonator having three different dimensions, as measured along the orthogonal axes (such as along x, y, and z axes). These dimensions may be referred to, without limitation, as width, length, and height. In one example, these dimensions may be similar but unequal, so that tri-mode resonator 706 supports three resonant modes having similar but unequal frequencies. For example, each dimension of tri-mode resonator 706 may differ from all the others by less than 50%, less than 20%, or less than 15%, etc. For three orthogonal modes, each resonant frequency may differ from all the others by less than 50%, less than 20%, or less than 15%, etc.

In some examples, a resonator may include and/or represent one or more stepped surface profiles, spatially varied dimensions (e.g., varied width, height, and/or length), corner cuts, modifications to a generally cuboid form factor, and/or any other modifications to support a plurality of modes. In one example, the configuration of the input and/or output slots may be adjusted to modify the filter bandwidth, and the length of one or more of the various slots may be adjusted to modify the filter bandwidth. For example, a U-shaped slot may include and/or represent first and second parallel slots connected by a third slot at one end of the parallel slots. In this example, the first and second U-shaped slots may be shifted, rotated, and/or offset with respect to each other. In one embodiment, the combination of a single-mode input resonator, a tri-mode resonator, and a single-mode output resonator may provide and/or represent a 5-pole filter.

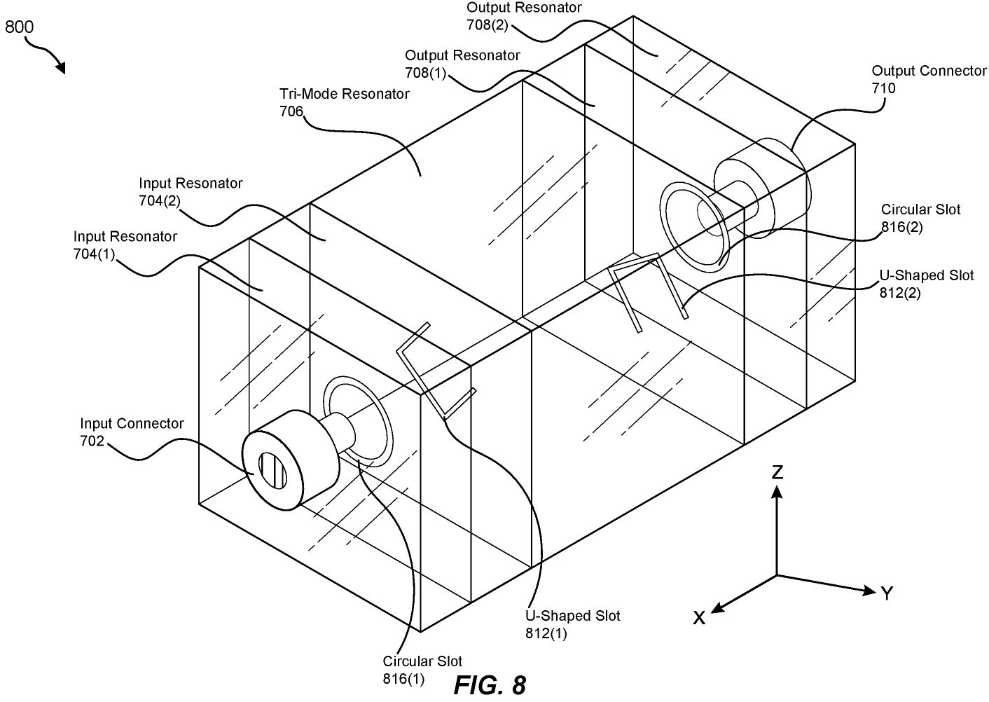

FIG. 8 illustrates an exemplary ceramic waveguide multi-mode bandpass filter 800. As illustrated in FIG. 8, exemplary ceramic waveguide multi-mode bandpass filter 800 may include and/or represent many of the same features discussed above in connection with FIG. 7. For example, exemplary ceramic waveguide multi-mode bandpass filter 800 may include and/or represent input connector 702 coupled to single-mode input resonators 704(1), a circular slot 816(1) coupling a single-mode input resonator 704(1) to single-mode input resonator 704(2), a U-shaped slot 812(1) coupling single-mode input resonator 704(2) to tri-mode resonator 706, a U-shaped slot 812(2) coupling tri-mode resonator 706 to single-mode output resonator 708(1), a circular slot 816(2) coupling single-mode output resonator 708(1) to a single-mode output resonator 708(2), and output connector 710 coupled to output resonator 708(2). Accordingly, exemplary ceramic waveguide multi-mode bandpass filter 800 may be classified as a 1:1:3:1:1 filter for a total of 7 modes, as the tri-mode resonator is located between a pair of single-mode input resonators and a pair of single-mode output resonators.

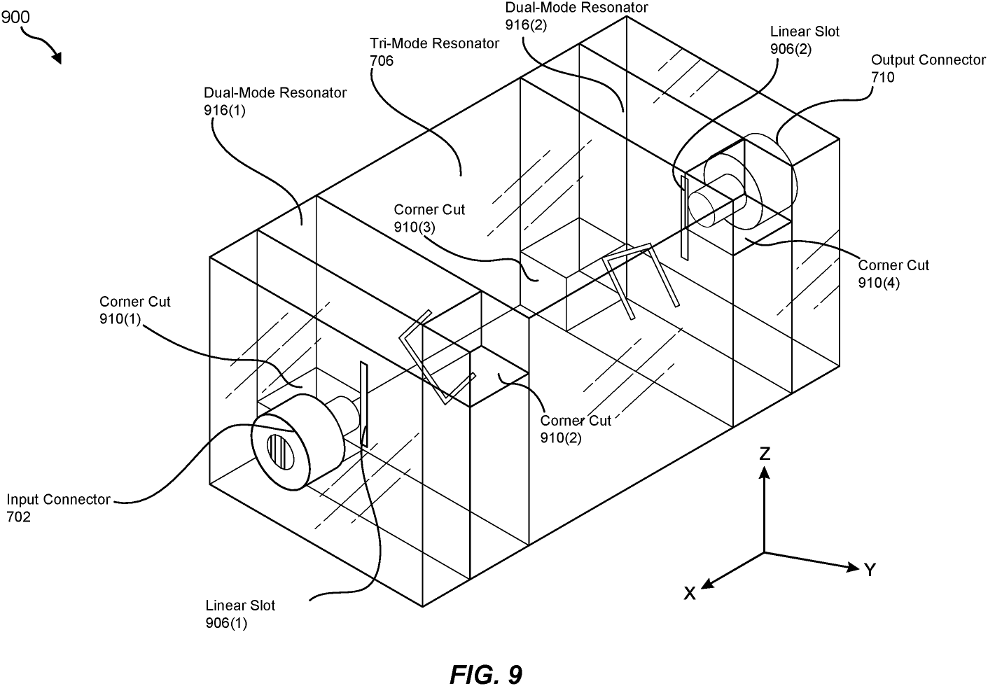

FIG. 9 illustrates an exemplary ceramic waveguide multi-mode bandpass filter 900 in which corner cuts are used to provide a two-mode or dual-mode resonator. As illustrated in FIG. 9, exemplary ceramic waveguide multi-mode bandpass filter 900 may include and/or represent many of the same features discussed above in connection with FIG. 8. For example, exemplary ceramic waveguide multi-mode bandpass filter 900 may include and/or represent input connector 702 coupled to single-mode input resonator 704(1), a linear slot 906(1) coupling single-mode input resonator 704(1) to a dual-mode input resonator 916(1), U-shaped slot 812(1) coupling dual-mode input resonator 916(1) to tri-mode resonator 706, U-shaped slot 812(2) coupling tri-mode resonator 706 to a dual-mode output resonator 916(2), a linear slot 906(2) coupling single-mode output resonator 708(1) to single-mode output resonator 708(2), and output connector 710 coupled to output resonator 708(2).

In some examples, dual-mode resonator 916(1) may include and/or form corner cuts 910(1) and 910(2), which effectively convert and/or enable the dual-mode operation for the resonator. Similarly, dual-mode resonator 916(2) may include and/or form corner cuts 910(3) and 910(4), which effectively convert and/or enable the dual-mode operation for the resonator.

In some examples, the signal may flow from input connector 702 generating a single mode in input resonator 704(1), which is followed by linear slot 906(1) coupling the signal to two modes in dual-mode resonator 916(1). In such examples, dual-mode resonator 916(1) may be coupled to tri-mode resonator 706 through a U-shaped slot generating the three modes in tri-mode resonator 706. In one example, the signal may then pass through a mirrored U-shaped slot that down-converts the 3 modes of tri-mode resonator 706 to dual-mode resonator 916(2) and then to a single-mode input resonator 704(1) through a linear and/or rectangular slot. This configuration may provide a 1:2:3:2:1 mode filter for a total of 9 modes.

In other embodiments, RF devices with different configurations and/or different numbers of modes may also be fabricated (e.g., 1:1:2:3:2:1:1, 1:2:2:3:2:2:1, or any other suitable configuration). Some filters may include and/or represent one or more tri-mode filters. Such tri-mode filters may be adjacent to each other or separated by one or more single-mode or dual-mode filters.

One or more input resonators may include and/or represent single-mode or dual-mode resonators. One or more output resonators may include single-mode or dual-mode resonators. A filter may include one or more tri-mode resonators. In some examples, a filter may include a configuration of single and/or dual-mode filters. A resonator having a corner cut may include and/or form a generally cuboid shaped piece of material (e.g., ceramic) has been removed. In some examples, a resonator may include and/or form a plurality of corner cuts.

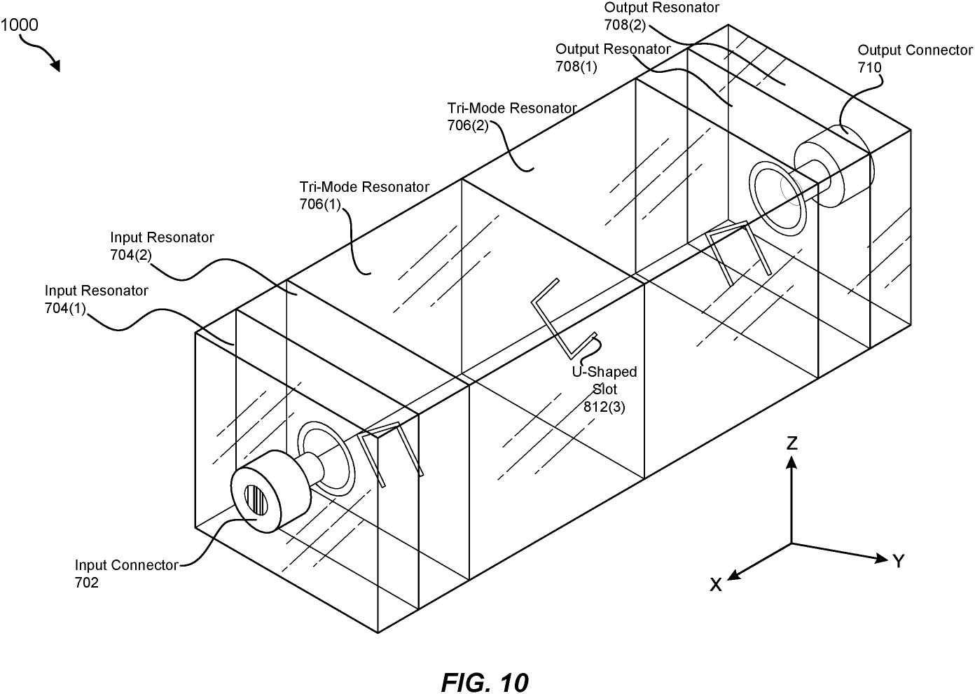

FIG. 10 illustrates an exemplary ceramic waveguide multi-mode bandpass filter 1000 that includes multiple tri-mode resonators. As illustrated in FIG. 10, exemplary ceramic waveguide multi-mode bandpass filter 1000 may include and/or represent many of the same features discussed above in connection with FIG. 8. For example, For example, exemplary ceramic waveguide multi-mode bandpass filter 1000 may include and/or represent input connector 702 coupled to single-mode input resonators 704(1), circular slot 816(1) coupling single-mode input resonator 704(1) to single-mode input resonator 704(2), U-shaped slot 812(1) coupling single-mode input resonator 704(2) to a tri-mode resonator 706(1), a U-shaped slot 812(3) coupling tri-mode resonator 706(1) to a tri-mode resonator 706(2), U-shaped slot 812(2) coupling tri-mode resonator 706(2) to single-mode output resonator 708(1), circular slot 816(2) coupling single-mode output resonator 708(1) to single-mode output resonator 708(2), and output connector 710 coupled to output resonator 708(2). Accordingly, exemplary ceramic waveguide multi-mode bandpass filter 1000 may be classified as a 1:1:3:3:1:1 filter for a total of 10 modes, as the two tri-mode resonators are located between a pair of single-mode input resonators and a pair of single-mode output resonators.

In some examples, a slot (such as a rectangular slot, a circular slot, a ringshaped slot, an elliptical slot, a U-shaped slot, an H-shaped slot, an L-shaped slot, a rectangular outline slot, a linear slot, or a corresponding combination) may be formed in an electrically conductive layer within an RF device. An electrically conductive layer may include and/or contain one or more metals, such as gold, silver, platinum, palladium, copper, aluminum, an alloy, and/or any other suitable metal (e.g., a transition metal). In one example, the electrically conductive layer may have a thickness between 1 micron and 5 millimeters.

In some examples, a multi-mode resonator may include and/or represent a resonator configured to support a plurality of resonant modes, at least two of which having different resonant frequencies. In one example, a multi-mode resonator may include a generally cuboid shape having orthogonal edge dimensions that may be denoted a, b, and c. For a perfect cube, the dimensions of a, b, and c may be identical to one another. A cubic resonator may support and/or provide three orthogonal resonances having the same resonant frequencies. However, by introducing differences between a, b, and/or c, the resonator may be configured to support three orthogonal modes with different resonant frequencies. A dual-mode resonator may include and/or represent a cuboid with two similar edge lengths, providing two similar resonant frequencies and one different resonant frequency. A tri-mode resonator may have three different orthogonal edge lengths that support three orthogonal resonant modes, each having a different resonant frequency. The differences in resonant frequencies may be small, for example, less than 50% frequency differences for any pair of resonant frequencies (e.g., approximately equal to or less than 20%).

In some examples, the frequency parameters of an RF device (e.g., including the bandwidth and/or center frequency of one or more pass bands of a bandpass filter) may be determined and/or modified by insertion, replacement, and/or adjustment of device components (such as bandpass filters). In such examples, one or more filters within an RF device may be easily replaceable to facilitate configuring the RF device to operate within desired frequency bands, such as cellphone or other communication network signals within a particular location. In one example, an RF device may be assembled and/or be reconfigured using a modular approach, including removable and replaceable filter modules.

In some examples, a filter may include an arrangement of ceramic resonators configured as a single band or multi-band bandpass filter. In such examples, the filter may include and/or represent electrical connectors to receive an input signal and provide an output signal. The electrical connectors may mechanically and/or electrically engage or mate with corresponding device connectors (e.g., a socket, slot, coaxial connector, waveguide connector, and/or any other suitable connector).

In some examples, an RF device may be reversible, having a first operational mode in which signals pass in a first direction, and a second operational mode in which signals pass in the reverse direction, so that the input and output are reversed. In other examples, an RF device (e.g., a multi-band and/or a multi-mode filter) may receive an input signal through a suitably configured input waveguide. The output signal may be transmitted through a suitably configured output waveguide. In one example, the input and/or output waveguide may be integrated with filter elements within the RF device.

In some examples, the RF device may be implemented in any variety of applications (e.g., cellphone network devices, 4G devices, 5G devices, LTE devices, and/or ground stations) and/or multiple-input multiple-output (MIMO) data transmission devices. Additionally or alternatively, device dimensions may be appropriately scaled for other applications, such as millimeter wave devices, microwave devices, satellite communication devices, and the like.

In some examples, one or more resonators (and optionally coupling structures) may be fabricated from a monolithic block of ceramic. In other examples, an RF device may be assembled from separate resonators, coupling structures, waveguides, and the like. In one example, a resonator may be fabricated including one or more coupling structures (e.g., irises, slots, narrowed portions, apertures, and the like).

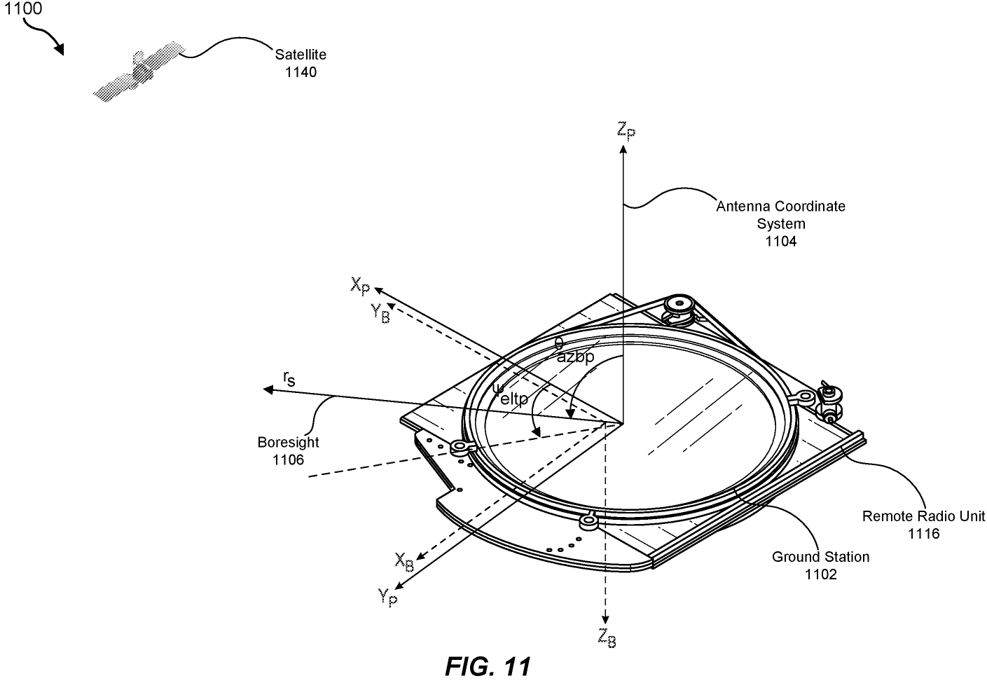

FIG. 11 illustrates an exemplary system 1100 in which a ground station 1102 tracks a satellite 1140 passing overhead. As illustrated in FIG. 11, ground station 1102 may steer, direct, and/or aim a boresight 1106 of an antenna in a certain direction in an effort to track and/or follow satellite 1140. In some examples, ground station 1102 may include and/or represent a remote radio unit 1112. In such examples, remote radio unit 1112 may include and/or represent one or more instances of RF device 100, 300, 400, or 500 as described above. Additionally or alternatively, satellite 1140 may include and/or represent one or more instances of RF device 100, 300, 400, or 500 as described above. In one example, each instance of RF device 100, 300, 400, or 500 may include and/or represent a RF circuit communicatively coupled directly or indirectly to the antenna. Accordingly, one or more RF components may be coupled between the RF circuit and the antenna.

In some examples, ground station 1102 may steer, direct, and/or aim boresight 1106 in accordance with an antenna coordinate system 1104. In one example, antenna coordinate system 1104 may implement and/or operate an overall pointing formula of (θ_{el_m},Ψ_{az_m})=ƒ(θₑₗₜₚ,Ψ_{azbp}),which facilitates mapping angles of boresight 1106 to the displacement angles of the azimuth and elevation motors. This pointing formula may lead to an azimuth formula of

$$θ = \text{asin(2sin} \left(\frac{{θ}_{r}}{2}\right) )$$

and/or an elevation formula of

$$ϕ = ( \frac{{θ}_{r}}{2} + s i g n ( {θ}_{r} ) \times 90 )$$

.

In one example, antenna coordinate system 1104 may include and/or represent a body coordinate frame denoted in FIG. 11 with the subscript “B” and a pointing coordinate frame denoted in FIG. 11 with the subscript “P” In this example, the body coordinate frame may be right-handed with the z-axis pointing downward, and the pointing coordinate frame may be right-handed with the z-axis pointing upward. Additionally or alternatively, boresight 1106 may be defined and/or aimed by (1) an elevation angle positioned between the beam-pointing vector and the x_{P}y_{P} plane and (2) an azimuth angle measured from the xₚ axis.

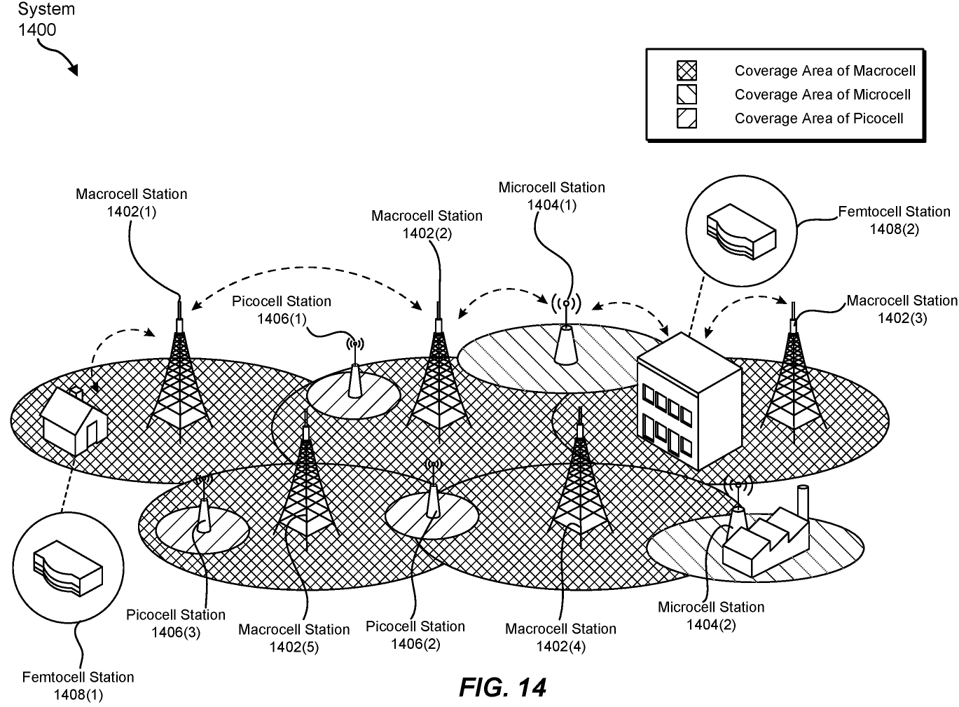

In addition to the satellite application described above in connection with FIG. 11, various telecommunication applications may include and/or implement one or more of the RF devices described above. For example, FIG. 14 illustrates an exemplary system 1400 in which various base stations are able to directly and/or indirectly communicate with one another. As illustrated in FIG. 14, exemplary system 1400 may include and/or represent macrocell stations 1402(1), 1402(2), 1402(3), 1402(4), and/or 1402(5), microcell stations 1404(1) and/or 1404(2), picocell stations 1406(1), 1406(2), and/or 1406(3), and/or femtocell stations 1408(1) and/or 1408(2). In some examples, any or all of the various base stations in FIG. 14 (e.g., macrocell stations 1402(1)-(5), microcell stations 1404(1)-(2), picocell stations 1406(1)-(3), and/or femtocell stations 1408(1)-(2)) may include and/or represent one or more instances of RF device 100, 300, 400, or 500 as described above. In these examples, such instances of RF devices may enable any or all of the various base stations in FIG. 14 to communicate with one another via wireless links and/or connections.

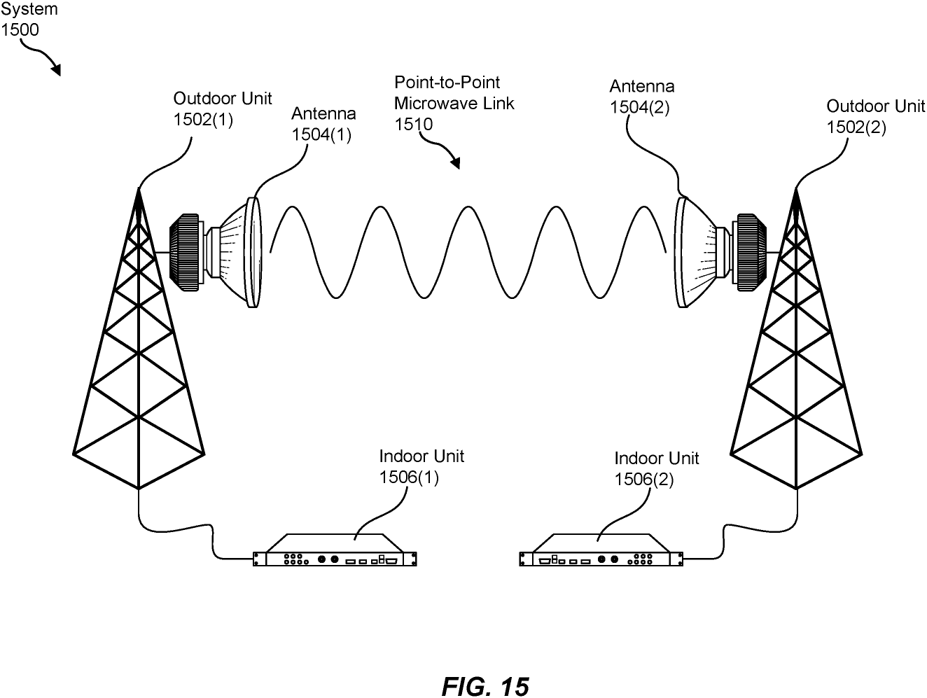

As another example, FIG. 15 illustrates an exemplary system 1500 in which a pair of base stations are able to directly and/or indirectly communicate with one another via a point-to-point microwave link 1510. As illustrated in FIG. 15, exemplary system 1500 may include and/or represent outdoor units 1502(1) and 1502(2) communicatively coupled to indoor units 1506(1) and 1506(2), respectively. In some examples, outdoor units 1502(1)-(2) may include and/or incorporate antennas 1504(1) and 1504(2), respectively. In such examples, one or more of antennas 1504(1)-(2) may include and/or represent one or more instances of RF device 100, 300, 400, or 500 as described above. In one example, such instances of RF devices may enable one or more of antennas 1504(1)-(2) to communicate with one another via point-to-point microwave link 1510.

FIG. 13 is a flow diagram of an exemplary method 1300 for achieving improved ground station design. In one example, the steps shown in FIG. 13 may be performed during and/or as part of the manufacture and/or assembly of a ground station. Additionally or alternatively, the steps shown in FIG. 13 may also incorporate and/or involve various sub-steps and/or variations consistent with the descriptions provided above in connection with FIGS. 1-12.

As illustrated in FIG. 13, method 1300 may include and/or involve the step of forming a plurality of signal paths that each include a ceramic material and have a bandpass center frequency different from every other signal path included in the plurality of signal paths (1310). Step 1310 may be performed in a variety of ways, including any of those described above in connection with FIGS. 1-12. For example, a communications equipment vendor or subcontractor may form and/or create a plurality of signal paths that each include a ceramic material and have a bandpass center frequency different from every other signal path included in the plurality of signal paths.

Method 1300 may also include the step of coupling a ceramic input resonator to the plurality of signal paths (1320). Step 1320 may be performed in a variety of ways, including any of those described above in connection with FIGS. 1-12. For example, the communications equipment vendor or subcontractor may couple and/or connect a ceramic input resonator to the plurality of signal paths.

Method 1300 may further include the step of coupling a ceramic output resonator to the plurality of signal paths (1330). Step 1330 may be performed in a variety of ways, including any of those described above in connection with FIGS. 1-12. For example, the communications equipment vendor or subcontractor may couple and/or connect a ceramic output resonator to the plurality of signal paths.

### Example Embodiments

Example 1: A radio-frequency device comprising (1) an input resonator configured to receive an input signal, (2) an output resonator configured to provide an output signal, and (3) a plurality of signal paths coupled between the input resonator and the output resonator, wherein each signal path included the plurality of signal paths comprises a bandpass filter that (A) is at least partially composed of a ceramic material and (B) has a bandpass center frequency different from every other signal path included in the plurality of signal paths.

Example 2: The radio-frequency device of Example 1, wherein the bandpass filter of each signal path includes a plurality of additional resonators coupled between the input resonator and the output resonator.

Example 3: The radio-frequency device of Example 1 or 2, wherein the bandpass center frequency of each signal path is defined at least in part by one or more dimensions of the additional resonators coupled between the input resonator and the output resonator.

Example 4: The radio-frequency device of any of Examples 1-3, wherein the bandpass center frequency of each signal path is defined at least in part by a volume of a cavity within one or more of the additional resonators coupled between the input resonator and the output resonator.

Example 5: The radio-frequency device of any of Examples 1-4, further comprising a plurality of inductive irises coupled between the plurality of additional resonators.

Example 6: The radio-frequency device of any of Examples 1-5, wherein a bandwidth of each signal path is defined at least in part by one or more dimensions of the inductive irises.

Example 7: The radio-frequency device of any of Examples 1-6, further comprising at least one capacitive iris coupled between the plurality of additional resonators.

Example 8: The radio-frequency device of any of Examples 1-7, further comprising at least one inductive iris coupled along with the capacitive iris between the plurality of additional resonators such that the capacitive iris and the inductive iris form a parallel resonance circuit.

Example 9: The radio-frequency device of any of Examples 1-8, wherein the additional resonators included in the bandpass filter of each signal path comprise a total of four resonators coupled together between the input resonator and the output resonator.

Example 10: The radio-frequency device of any of Examples 1-9, wherein the plurality of signal paths comprise two signal paths that substantially mirror each other such that each of the two signal paths include a total of four resonators coupled together between the input resonator and the output resonator.

Example 11: The radio-frequency device of any of Examples 1-10, wherein the two signal paths comprise (1) a first signal path forming a first bandpass filter with a first bandpass center frequency and (2) a second signal path forming a second bandpass filter with a second bandpass center frequency, the second bandpass center frequency being at least 10% higher than the first bandpass center frequency.

Example 12: The radio-frequency device of any of Examples 1-11, wherein at least one of (1) the first bandpass center frequency is outside of a second pass band of the second signal path or (2) the second bandpass center frequency is outside of a first pass band of the first signal path.

Example 13: The radio-frequency device of any of Examples 1-12, wherein the additional resonators included in the bandpass filter of each signal path comprise a total of six resonators coupled together along each signal path between the input resonator and the output resonator.

Example 14: The radio-frequency device of any of Examples 1-13, wherein the input resonator and the output resonator are each at least partially composed of a ceramic material.

Example 15: The radio-frequency device of any of Examples 1-14, wherein the input resonator and the output resonator are each at least partially composed of a ceramic material.

Example 16: The radio-frequency device of any of Examples 1-15, wherein the input resonator and the output resonator are each at least partially composed of a ceramic material.

Example 17: The radio-frequency device of any of Examples 1-16, wherein the input resonator and the output resonator are each at least partially composed of a ceramic material.

Example 18: The radio-frequency device of any of Examples 1-17, wherein the input resonator and the output resonator are each at least partially composed of a ceramic material.

Example 19: A system comprising (1) a radio-frequency circuit comprising (A) an input resonator configured to receive an input signal, (B) an output resonator configured to provide an output signal, and (C) a plurality of signal paths coupled between the input resonator and the output resonator, wherein each signal path included the plurality of signal paths comprises a bandpass filter that (I) is at least partially composed of a ceramic material and (II) has a bandpass center frequency different from every other signal path included in the plurality of signal paths, and (2) an antenna communicatively coupled to the radio-frequency circuit.

Example 20: A method comprising (1) forming a plurality of signal paths that each (A) include a ceramic material and (B) have a bandpass center frequency different from every other signal path included in the plurality of signal paths, (2) coupling a ceramic input resonator to the plurality of signal paths, and (3) coupling a ceramic output resonator to the plurality of signal paths.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms ”a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A radio-frequency device comprising:
an input resonator configured to receive an input signal;
an output resonator configured to provide an output signal; and
a plurality of signal paths coupled between the input resonator and the output resonator, wherein each signal path included the plurality of signal paths comprises a bandpass filter that:
is at least partially composed of a ceramic material; and
has a bandpass center frequency different from every other signal path included in the plurality of signal paths.

2. The radio-frequency device of claim 1, wherein the bandpass filter of each signal path includes a plurality of additional resonators coupled between the input resonator and the output resonator.

3. The radio-frequency device of claim 2, wherein the bandpass center frequency of each signal path is defined at least in part by one or more dimensions of the additional resonators coupled between the input resonator and the output resonator.

4. The radio-frequency device of claim 2, wherein the bandpass center frequency of each signal path is defined at least in part by a volume of a cavity within one or more of the additional resonators coupled between the input resonator and the output resonator.

5. The radio-frequency device of claim 2, further comprising a plurality of inductive irises coupled between the plurality of additional resonators.

6. The radio-frequency device of claim 5, wherein a bandwidth of each signal path is defined at least in part by one or more dimensions of the inductive irises.

7. The radio-frequency device of claim 6, further comprising at least one capacitive iris coupled between the plurality of additional resonators.

8. The radio-frequency device of claim 7, further comprising at least one inductive iris coupled along with the capacitive iris between the plurality of additional resonators such that the capacitive iris and the inductive iris form a parallel resonance circuit.

9. The radio-frequency device of claim 2, wherein the additional resonators included in the bandpass filter of each signal path comprise a total of four resonators coupled together between the input resonator and the output resonator.

10. The radio-frequency device of claim 9, wherein the plurality of signal paths comprise two signal paths that substantially mirror each other such that each of the two signal paths include a total of four resonators coupled together between the input resonator and the output resonator.

11. The radio-frequency device of claim 10, wherein the two signal paths comprise:
a first signal path forming a first bandpass filter with a first bandpass center frequency; and
a second signal path forming a second bandpass filter with a second bandpass center frequency, the second bandpass center frequency being at least 10% higher than the first bandpass center frequency.

12. The radio-frequency device of claim 11, wherein at least one of:
the first bandpass center frequency is outside of a second pass band of the second signal path; or
the second bandpass center frequency is outside of a first pass band of the first signal path.

13. The radio-frequency device of claim 2, wherein the additional resonators included in the bandpass filter of each signal path comprise a total of six resonators coupled together along each signal path between the input resonator and the output resonator.

14. The radio-frequency device of claim 1, wherein the input resonator and the output resonator are each at least partially composed of a ceramic material.

15. The radio-frequency device of claim 1, wherein each signal path included in the plurality of signal paths comprises a ceramic waveguide.

16. The radio-frequency device of claim 1, further comprising:
a ceramic multi-mode resonator that forms the plurality of signal paths coupled between the input resonator and the output resonator;
a first U-shaped slot coupled between the input resonator and the ceramic multi-mode resonator; and
a second U-shaped slot coupled between the ceramic multi-mode resonator and the output resonator.

17. The radio-frequency device of claim 16, wherein the ceramic multi-mode resonator is configured to support a plurality of resonant modes for at least two different resonant frequencies.

18. The radio-frequency device of claim 16, wherein the ceramic multi-mode resonator comprises a ceramic cuboid having at least two different orthogonal dimensions.

19. A system comprising:
a radio-frequency circuit comprising:
an input resonator configured to receive an input signal;
an output resonator configured to provide an output signal; and
a plurality of signal paths coupled between the input resonator and the output resonator, wherein each signal path included the plurality of signal paths comprises a bandpass filter that:
is at least partially composed of a ceramic material; and
has a bandpass center frequency different from every other signal path included in the plurality of signal paths; and
an antenna communicatively coupled to the radio-frequency circuit.

20. A method comprising:
forming a plurality of signal paths that each:
include a ceramic material; and
have a bandpass center frequency different from every other signal path included in the plurality of signal paths;
coupling a ceramic input resonator to the plurality of signal paths; and
coupling a ceramic output resonator to the plurality of signal paths.
